(19) United States
(12) Patent Application Publication
(10) Pub. No.: US 2013/0284476 A1
(43) Pub. Date: Oct. 31, 2013

(54) HAND POWER TOOL

(71) Applicant: ROBERT BOSCH GMBH, Stuttgart (DE)

(72) Inventors: Andre Ullrich, Leinfelden-Echterdingen (DE); Holger Ruebsaamen, Stuttgart (DE)

(73) Assignee: Robert Bosch GmbH, Stuttgart (DE)

(21) Appl. No.: 13/868,251

(22) Filed: Apr. 23, 2013

(30) Foreign Application Priority Data
Apr. 26, 2012 (DE) 10 2012 206 884.8

(51) Int. Cl. B25F 5/02

(52) U.S. Cl. CPC B25F 5/02
USPC 173/170

(57) ABSTRACT

A hand power tool includes at least one drive unit, at least one housing, and at least one switchover element. The at least one drive unit is configured to drive an insert tool. The at least one housing at least partially encloses the drive unit. The at least one switchover element is configured to switch over a drive direction of the at least one drive unit. The at least one switchover element includes at least one actuating face that has at least two switching positions. The at least one actuating face is at least partially configured such that, when in the at least two switching positions, the at least one actuating face is at least substantially flush with the at least one housing.

This application claims priority under 35 U.S.C. §119 to patent application no. DE 10 2012 206 884.8, filed on Apr. 26, 2012 in Germany, the disclosure of which is incorporated herein by reference in its entirety.

### BACKGROUND

There are already known hand power tools.

### SUMMARY

The disclosure is based on a hand power tool having at least one drive unit, which is provided to drive an insert tool, having at least one housing, which at least partially encloses the drive unit, and having at least one switchover element, which is provided for switching over a drive direction of the at least one drive unit and which comprises at least one actuating face that has at least two switching positions.

It is proposed that the at least one actuating face, in the at least two switching positions, is realized, at least partially, so as to be at least substantially flush with the housing. The drive unit can preferably comprise a motor, in particular an electric motor. “Provided” is to be understood to mean, in particular, specially configured and/or equipped. A “drive direction” in this context is to be understood to mean, in particular, a direction in which the drive unit delivers, or, in particular transmits to a motor shaft, in particular, at least 40%, preferably at least 50%, preferably at least 65%, and particularly preferably at least 80% of a kinetic energy of the drive unit. In a particularly preferred exemplary embodiment, the drive direction is constituted, at least partially, by a direction of rotation. An “actuating face” in this context is to be understood to mean, in particular, a face provided, at least substantially, to serve as an interface between an operator of the hand power tool and the switchover element, for the purpose of direct contacting by the operator, and/or via which at least a force is transmitted from an operator, in particular directly, on to the switchover element upon at least one switchover movement. A “switching position” in this context is to be understood to mean, in particular, a stop position of the switchover element that in each case defines a state desired by an operator, in particular when the hand power tool is in an operating state, particularly preferably in each case a drive direction, in particular a direction of rotation, of the drive unit. The switching positions can preferably be achieved through a mechanical displacement of the switchover element by an operator, by means of the at least one actuating face. “At least partially flush” in this context is to be understood to mean, in particular, that a contour, in particular of a part of the actuating face, as viewed perpendicularly in relation to a surface of the housing, in particular in a region adjoining the actuating face, projects, in particular, by less than 5 mm, preferably less than 3 mm, and particularly preferably less than 1 mm beyond the surface of the housing, and that the surface of the housing, as viewed perpendicularly in relation to the surface of the housing, projects, in particular, by less than 5 mm, preferably less than 3 mm, and particularly preferably less than 1 mm beyond the contour, in particular, of a part of the actuating face. It is therefore also conceivable for the actuating face, as viewed from the outside, perpendicularly in relation to the surface of the housing, to be disposed, at least partially, maximally 5 mm beneath the surface of the housing. In a particularly preferred exemplary embodiment, the actuating face is realized so as to be at least partially level with the surface of the housing. In a particularly preferred exemplary embodiment, the at least one actuating face, in the at least two switching positions, is realized so as to be at least substantially completely flush with the housing.

The configuration according to the disclosure makes it possible, in particular, to achieve an advantageously high degree of operating comfort for an operator, in particular when guiding the hand power tool in at least one operating state. Owing to the at least partially flush configuration of the actuating face, it is advantageously possible to reduce and, particularly preferably, to prevent fully, at least substantially, pressing of the switchover element, in a region of the actuating face, in particular during guiding of the hand power tool, into the inside of the operator's hand, which is unpleasant for an operator.

Furthermore, it is proposed that the at least one switchover element has at least one profiled region, which constitutes at least a part of the at least one actuating face. A “profiled region” in this context is to be understood to mean, in particular, a region of the switchover element having at least one protrusion that, as viewed perpendicularly in relation to a region, projects beyond a region of the actuating face that surrounds the profiled region by, in particular, at least 1 mm, preferably at least 3 mm, and particularly preferably maximally 5 mm The profiled region can preferably comprise a plurality of protrusions. The profiled region can project at least partially beyond a surface of the housing, the maximum height of the profiled region, as viewed perpendicularly in relation to the region, being, in particular, at most 5 mm, preferably at most 3 mm, and particularly preferably at most 1 mm out from the surface. It is thereby possible to achieve a preferably good transmission of force to the switchover element, in particular by an operator, in particular during changing of at least one switching position. In addition, through simple configuration means, it is possible to prevent slippage of a hand, in particular a finger, of the operator during actuation of the switchover element via the at least one actuating face.

In addition, it is proposed that the at least one profiled region is realized so as to be at least substantially flush with the housing. It is thereby possible to achieve a preferably pleasant and comfortable guidance of the hand power tool for an operator and, consequently, an advantageously high degree of operating comfort.

Further, it is proposed that the at least one switchover element comprises at least one transmission element, which is provided to transmit a switchover movement of the switchover element to at least one switching unit. In a particularly preferred exemplary embodiment, the transmission element is realized so as to be integral with the switchover element. “Integral with” is to be understood to mean, in particular, connected at least in a materially bonded manner, for example by a welding process, an adhesive bonding process, an injection process and/or by another process considered appropriate by persons skilled in the art, and/or, advantageously, formed in one piece, such as, for example, by being produced from a casting and/or by being produced in a single- or multi-component injection process and, advantageously, from a single blank. Through simple configuration means it is thereby possible to achieve a preferably reliable transmission of the switchover movement to the drive unit, and consequently an advantageously rapid switchover of the drive direction of the drive unit.

Furthermore, it is proposed that the hand power tool has at least one bearing element, which is provided, at least substantially, to support at least one switchover element such that it is at least partially pivotable about a pivot axis. “At least partially pivotable” in this context is to be understood to mean, in particular, rotatable by at least 10°, preferably by at least 20°, and particularly preferably by at least 30°. It is thereby possible to achieve a mounting that is of simple configuration and advantageously robust, and which in a structurally simple manner enables the actuating face, in the at least two switching positions, to be of a flush configuration.

Further, it is proposed that the at least one switchover element has at least one region that at least partially surrounds the at least one profiled region, and that is disposed in an at least partially inwardly offset manner relative to a surface of the housing. “Inwardly offset” in this context is to be understood to mean, in particular, that the region is disposed at last partially, preferably at least substantially completely, in front of the surface of the housing in the radial direction, as viewed outwardly from the pivot axis. The region is preferably disposed, at least partially, maximally 5 mm beneath the surface of the housing, as viewed from the outside, perpendicularly in relation to the surface of the housing. As a result, through simple configuration means, penetration of dirt or dust into an interior of the hand power tool, in the region of the switchover element, is advantageously reduced or at least substantially prevented.

In addition it is proposed that the pivot axis runs at least substantially parallelwise in relation to a handle region of the housing, whereby it is possible to achieve a preferably compact configuration of the hand power tool.

Further, it is proposed that the switchover element has at least two actuating faces, which are disposed oppositely, as viewed perpendicularly in relation to the pivot axis. Through simple configuration means it is thereby possible to achieve an advantageously flexible actuation of the at least one switchover element, in particular by an operator.

In addition, it is proposed that the at least two actuating faces are fixedly connected to each other. “Fixedly connected to each other” in this context is to be understood to mean, in particular, that a relative movement between the at least two actuating face is at least substantially prevented. Particularly preferably, the at least two actuating faces are in this case realized at a distance apart from each other. It is thereby possible, in an advantageously simple manner, to achieve actuation of the switchover element from at least two positions on the hand power tool, thereby enabling an advantageously high degree of operating comfort and a preferably high degree of flexibility to be achieved.

### BRIEF DESCRIPTION OF THE DRAWINGS

Further advantages are given by the following description of the drawing. The drawing shows an exemplary embodiment of the disclosure. The drawing and the description contain numerous features in combination. Persons skilled in the art will also expediently consider the features individually and combine them to create appropriate further combinations.

In the drawing:

FIG. 1 shows a hand power tool according to the disclosure, in a schematic representation,

FIG. 2 shows a portion of the hand power tool according to the disclosure, in a side view,

FIG. 3 shows a back view of the hand power tool according to the disclosure,

FIG. 4 shows a switchover element according to the disclosure, in a perspective view,

FIG. 5 shows a portion of the hand power tool according to the disclosure, and

FIG. 6 shows a further portion of the hand power tool according to the disclosure.

### DETAILED DESCRIPTION

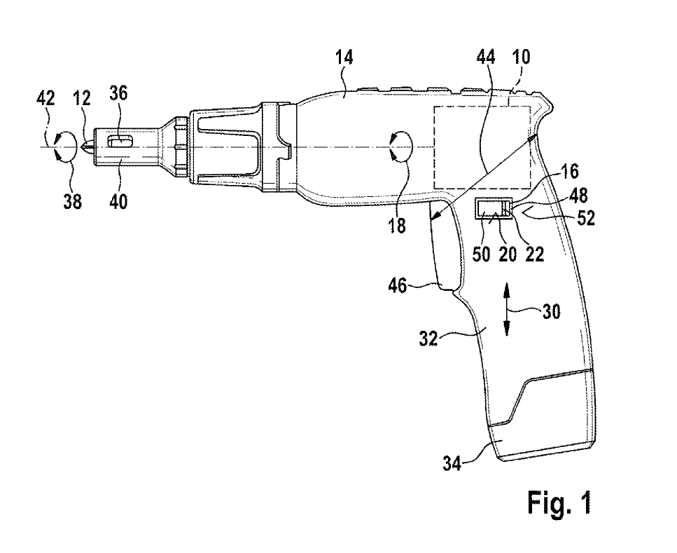

FIG. 1 shows a hand power tool, which is constituted by a drywall screwdriver. The hand power tool has a rechargeable battery 34, which is provided to supply electric power to a drive unit 10 of the hand power tool. The drive unit 10 is provided to drive an insert tool 12, which is held in a tool receiver 36 of the hand power tool. The tool receiver 36 is surrounded in a circumferential direction 38 by a depth stop element 40. The hand power tool has a housing 14, which encloses the drive unit 10. The housing 14 is composed of a plastic, and comprises two half shells, which correspond to each other. The housing 14 constitutes a handle region 32, which is provided to be encompassed by an operator. A direction of main extent 30 of the handle region 32 extends perpendicularly in relation to a working axis 42 of the insert tool 12. An operator of the hand power tool, when it is in an operating state, grasps the hand power tool along a grip circumference 44. The grip circumference 44 is disposed at an angle relative to the direction of main extent 30 of the handle region 32.

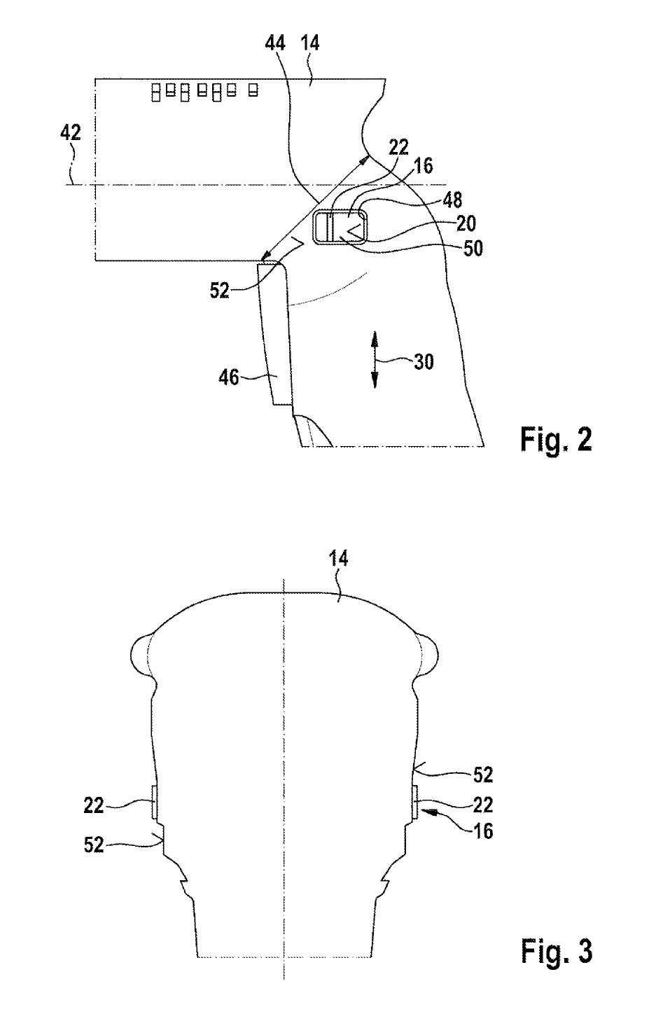

The hand power tool additionally has a switching element 46, which is provided for the purpose of activating the drive unit 10. The switching element 46 projects out of the housing 14 and is mounted so as to be displaceable linearly. The switching element 46 is operatively connected to the drive unit 10. The hand power tool additionally has a switchover element 16, which is provided for switching over a drive direction 18 of the drive unit 10. The switchover element 16 has two actuating faces 20, which each have two switching positions. The housing 14, as viewed perpendicularly in relation to the direction of main extent 30 of the handle region 32, has two opposing recesses 48, through which there extends, respectively, a part of an actuating face 20 of the switchover element 16 (FIG. 2).

The switchover element 16 has regions 50 disposed in an at least partially inwardly offset manner relative to a surface 52 of the housing 14. The switchover element 16 has regions 50 that, in the radial direction, as viewed outwardly from the pivot axis 28, is disposed in front of the housing 14. The region 50 of the switchover element 16, as viewed perpendicularly in relation to a surface 52 of the housing 14 that faces toward an operator, does not project beyond the latter. The switchover element 16 additionally has two profiled regions 22. The profiled regions 22 constitute the actuating faces 20 of the switchover element 16. The regions 50 surround the profiled regions 22. The profiled region 22, as viewed perpendicularly in relation to the surface 52 of the housing 14, projects beyond the region 50. The profiled region 22 is provided to enable force to be easily transmitted by an operator to the switchover element 16. In a mounted state, in both switching positions of the switchover element 16, the profiled region 22 is realized so as to be flush with the surface 52 of the housing 14 (FIG. 3). Alternatively, in a mounted state, in both switching positions of the switchover element 16, the profiled region 22 can be disposed merely a few millimeters in front of or behind the surface 52 of the housing 14. The profiled region 22 prevents slippage from the actuating face 20 during switchover of a drive direction 18 by an operator.

The switchover element 16 is positioned inside the housing 14 in such a way that the actuating faces 20 of the switchover element 16 does not have an overlap with the switching element 46, either along the working axis 42 of the insert tool 12 or in the direction of main extent 30 of the handle region 32 of the housing 14. The switching faces 20 are therefore disposed at least partially outside of the grip circumference 44, such that the profiled region 22 scarcely impedes or disturbs, or does not at all impede or disturb an operator when gripping the housing 14 along the grip circumference 44. In addition, owing to the described arrangement of the switchover element 16, the switching element 46 can be displaced, in the direction of main extent 30 of the handle region 32, toward the working axis 42, whereby a smaller grip circumference 44 is achieved.

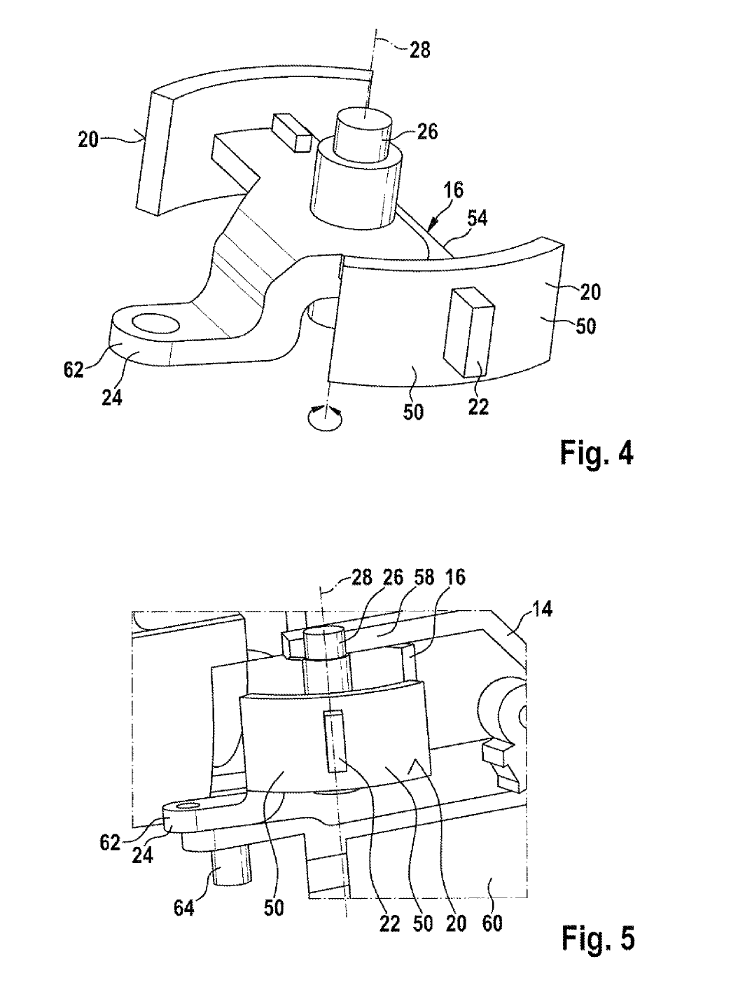

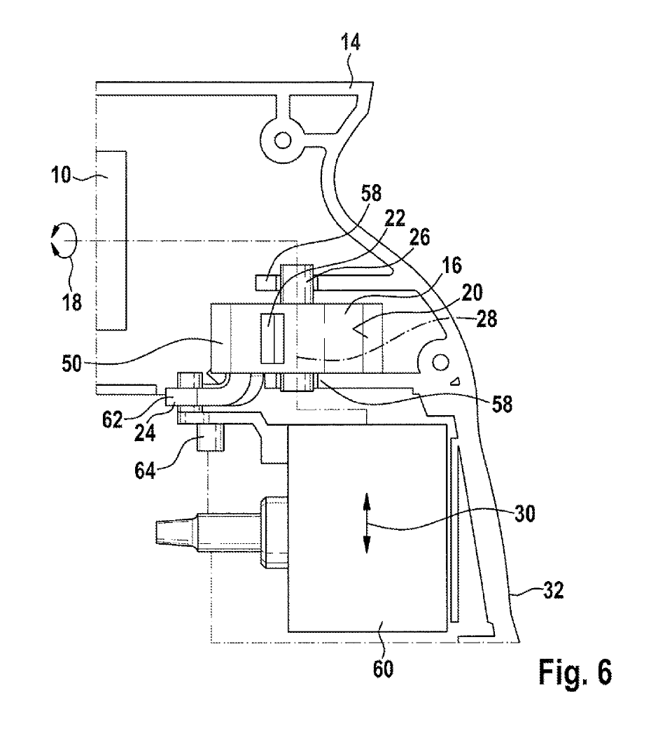

FIG. 4 shows the switchover element 16 in a demounted state. The switchover element 16 has two bearing elements 26, which are provided to mount the switchover element 16 so as to be pivotable about a pivot axis 28. The pivot axis 28 runs at least substantially parallelwise in relation to the direction of main extent 30 of the handle region 32 of the housing 14. The bearing elements 26 are disposed between the actuating faces 20 of the switchover element 16. The actuating faces 20 are fixedly connected to each other by means of a web 54. A direction of main extent 56 of the web 54 constitutes, respectively, a normal to the surface of the actuating faces 20. The bearing elements 26 are constituted by bearing studs, which extend parallelwise in relation to the actuating faces 20 and constitute the pivot axis 28. The bearing elements 26 are disposed, respectively, on opposing sides of the web 54. The bearing elements 26 are disposed centrally between the actuating faces 20. The bearing elements 26 are provided, when connected to the hand power tool, to engage in corresponding bearing elements 58 of the hand power tool. The corresponding baring elements 58, which are not represented in greater detail here, are connected to the housing 14 of the hand power tool. The corresponding bearing elements 58 are realized as reliefs in the housing 14.

The switchover element 16 has a transmission element 24, which is provided for the purpose of transmitting a switchover movement of the switchover element 16 to a switching unit 60. The transmission element 24 is constituted by a step-shaped element, which, at one end, is fixedly connected to the web 54 of the switchover element 16 and which, at an opposite end, has a transmission contour 62. The transmission contour 62 of the transmission element 24 constitutes a switching lever. The transmission element 24 transmits the switchover movement of the switchover element 16, by means of the transmission contour 62, to a rotational-direction switching lever 64 of the switching unit 60. A drive direction 18 of the drive unit 10 is thereby switched over, or changed. The drive unit 10 is constituted by an electric motor. The drive direction 18 is constituted by a direction of rotation. It is also conceivable, however, for the transmission element 24 of the switchover element 16 to contact the switching element 46 directly, and to transmit the switchover movement of the switchover element 16 directly to the switching element 46, and thus to the drive unit 10.

What is claimed is:

1. A hand power tool comprising:
at least one drive unit configured to drive an insert tool;
at least one housing configured to at least partially enclose the drive unit; and
at least one switchover element configured to switch over a drive direction of the at least one drive unit, the at least one switchover element including at least one actuating face that has at least two switching positions,
wherein the at least one actuating face is at least partially configured such that, when in the at least two switching positions, the at least one actuating face is at least substantially flush with the at least one housing.

2. The hand power tool according to claim 1, wherein the at least one switchover element has at least one profiled region constituting at least a part of the at least one actuating face.

3. The hand power tool according to claim 2, wherein the at least one profiled region is configured to be at least substantially flush with the at least one housing.

4. The hand power tool according to claim 1, wherein the at least one switchover element includes at least one transmission element configured to transmit a switchover movement of the at least one switchover element to at least one switching unit.

5. The hand power tool according to claim 1, further comprising:
at least one bearing element configured, at least substantially, to support the at least one switchover element such that the at least one switchover elemenet is at least partially pivotable about a pivot axis.

6. The hand power tool according to claim 2, wherein:
the at least one switchover element has at least one region configured to at least partially surround the at least one profiled region, and the at least one region is disposed in an at least partially inwardly offset manner relative to a surface of the at least one housing.

7. The hand power tool according to claim 5, wherein the pivot axis runs at least substantially parallelwise in relation to a direction of main extent of a handle region of the housing.

8. The hand power tool according to claim 5, wherein the at least one switchover element has at least two actuating faces disposed oppositely when viewed perpendicularly in relation to the pivot axis.

9. The hand power tool according to claim 8, wherein the at least two actuating faces are fixedly connected to each other.

10. A switchover element of a hand power tool comprising:
at least one actuating face that has at least two switching positions, wherein, the at least one actuating face is at least partially configured such that, when in the at least two switching positions, the at least one actuating face is at least substantially flush with at least one housing of the hand power tool.
